(19) United States
(12) Patent Application Publication
(10) Pub. No.: US 2013/0086436 A1
(43) Pub. Date: Apr. 4, 2013

(54) Device and Method for Checking Frames to be used by an Electronic Device of a Communication Network, on the Basis of Function Types and Using Parameters Contained in Said Frames

(71) Applicants: Lionel Antoniucci, La Garenne Colombes (FR); Cedric Wilert, Paris (FR)

(72) Inventors: Lionel Antoniucci, La Garenne Colombes (FR); Cedric Wilert, Paris (FR)

(73) Assignee: PEUGEOT CITROEN AUTOMOBILES SA, Velizy Villacoublay (FR)

(21) Appl. No.: 13/703,874

(22) PCT Filed: May 27, 2011
(86) PCT No.: PCT/FR11/51210

§ 371 Date: Dec. 12, 2012

(30) Foreign Application Priority Data
Jun. 16, 2010 (FR) 1054747

(51) Int. Cl. G06F 11/07

(52) U.S. Cl. CPC G06F 11/0763
USPC 714/49

(57) ABSTRACT

The invention relates to a device (D) for checking frames of groups of bits, received by an electronic device (O1) connected to a communication network (RC) and using at least one so-called non-secure-type local function. The device (D) includes checking means (MC) which, should an error occur in at least one group of bits in a frame received from the network (RC), are configured to force the electronic device (O1) to use as is at least each bit group of the received frame which is representative of a parameter of a non-secure-type local function used by said electronic device (O1).

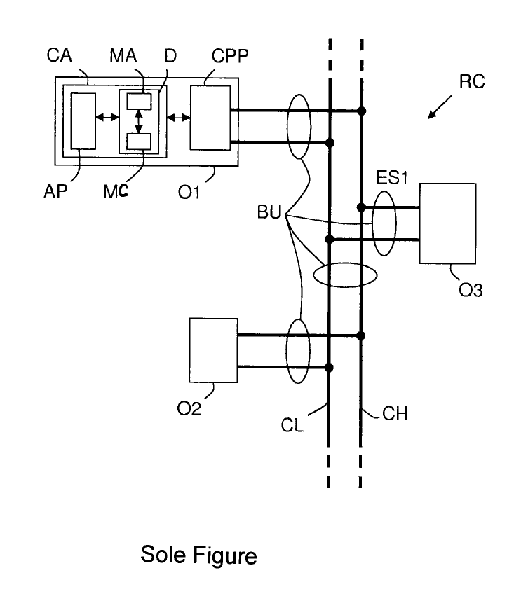

### CROSS-REFERENCE TO RELATED APPLICATIONS

This application is the US National Stage under 36 U.S.C. §371 of International App. No. PCT/FR2011/051210 filed May 27, 2011, which claims priority to French App. No. 1054747 filed Jun. 16, 2010.

### BACKGROUND

The invention relates to electronic devices capable of communicating among themselves via a communication network and more precisely to the checking or control of frames received by such electronic devices.

Certain communication networks comprise a bus to which communicating electronic devices are connected in parallel. The exchanges of data among communicating electronic devices is then made via the bus by means of multiplexed frames. The term “frame” denotes here a unit of groups of bits that, for at least some of them, are representative of values of parameters that are used by the local functions in the electronic devices.

Among these networks those of the type CAN LS (“Controller Area Network Low Speed”), or CAN HS (“Controller Area Network High Speed”), or VAN (“Vehicle Area Network”) or LIN (“Local Interconnect Network”) or also FlexRay can be cited in particular. Such networks are used in numerous areas and especially in that of vehicles (in particular, automobiles).

As the person skilled in the art knows, the environment in which information frames are developed that the electronic devices of the previously cited communication networks exchange can be disturbed by an external element (such as, for example, an electromagnetic disturbance) or by an internal error connected to the physical layers that are charged with the transmission of information data (such as, for example, a clock drift or a problem of encapsulation). These disturbances, that can be of a transitory nature, cause errors among the frame bits. These errors constitute approximately 90% of what one generally calls electronic deficiencies and the remaining 10% concern permanent problems (such as, for example, a bundle cut, a disconnection or a grounding).

In order to permit the electronic devices to detect errors in the frames that they receive, secure information is added to the latter such as, for example, a CRC (Check of Cyclic Redundancy), a checksum and/or a process counter. When an electronic device receives a frame it calculates the previously cited secure information starting from bits that it contains, then it compares this calculated secure information with those in the frame considered. In the case of identity, the frame is considered as valid, whereas in the case of a difference or differences, the frame is considered as erroneous (or invalid).

When a received frame is erroneous, an application-oriented layer of the electronic device, such as, for example, the “Fault Handling CAN,” is charged with supplying the electronic device with a replacement frame (or overlay frame) comprising values of a parameter or parameters intended by default to make a local application function that it comprises in a mode called degraded. In other words, in the case of the detection of an error or errors in a frame, each local application that needs information contained in this erroneous frame is forced to use default values rather than the real values actually received.

Unfortunately, it can occur that in certain life phases, certain applications no longer function optimally when they are forced to use default parameter values contained in the replacement (or overlay) frames. This can result in particular from the fact that in certain cases certain default parameter values of a replacement frame force certain applications to act in a manner that is not, or is hardly, compatible with other actions permitted by the default values of other parameters of this same replacement frame. This can also result from the fact that overlay values do not reflect the real state in which the “emitter” function is found and consequently the “consumer” (or “user” or also “receiver”) function of the non-representative default value adopts a behavior that is not adapted to the real situation of the life of the vehicle.

In order to improve the situation it would of course be possible to calculate for each erroneous frame in a systematic manner and in real time default values compatible among themselves for each of the parameters that it contains, but this would entail a (very) significant slowing down of the operating speed of the electronic devices (at a constant calculating power), incompatible with the reaction times required by some of their local applications.

### SUMMARY

The invention therefore addresses the problem of improving the above-noted situation without requiring a significant increase of the calculating power of the electronic devices.

To this end, the invention first proposes a device intended to check or control frames of groups of bits received by an electronic member suitable for being connected to a communication network and using at least one local function of the type called non-secure, and comprises a check means designed in case of the presence in a frame received from the network of an error in at least one group of bits in order to force the electronic device to use as is at least each group of bits of this received frame that is representative of a parameter of a local function of the non-secure type used by the electronic device (including the data bits that are erroneous).

The device in accordance with the invention can comprise other characteristics that can be taken separately or in combination, and in particular:

The device can comprise analyzing means designed to determine the type of each local function using an erroneous detected bit group in such a manner as to point out the determined type to the check means. As a variant, the check means can be designed to determine the type of each local function using an erroneous detected bit group;

as a variant, the device's check means can be designed, in the case of a detection by the electronic device of a received frame containing at least one group representative of a parameter of a non-secure local function, then of the decision taken by this electronic device, to replace this erroneous detected frame by a replacement frame comprising replacement bit groups having selected values in order to force the electronic device to use as is at least each bit group of the erroneous detected frame representative of a parameter of at least one non-secure function instead of the replacement bit group contained in the replacement frame;
the device's check means can also be designed in the case of the presence in a frame received from the network of an error in at least one bit group representative of a parameter of a local function of the type called secure for forcing the electronic device to use a replacement bit group with a selected value instead of the erroneous secure bit group;
each selected value can be a predefined default value.

The invention also proposes an electronic device intended to be connected to a communication network and comprises a device for checking or controlling frames of the type of the one presented above.

The invention also proposes a process intended to check or control frames of groups of bits received by an electronic member suitable for being connected to a communication network and using at least one local function of the type called non-secure, and comprised in the case of detection in a frame received from the network of an error in at least one group of bits in order to force the electronic device to use as is at least each group of bits of the received frame that is representative of a parameter of a local function of the non-secure type used by this electronic device (including those that are erroneous).

This process can also comprise in case of the detection in a frame received from the network of an error in at least one bit group representative of a parameter of a local secure function in forcing the electronic device to use a replacement bit group with a selected value instead of the erroneous secure bit group.

The invention is particularly well adapted, although not in a limiting manner, to the communication networks that are incorporated in vehicles (in particular, automobiles).

### DESCRIPTION OF THE DRAWING

Other characteristics and advantages of the invention will appear from the examination of the following detailed description and from the attached drawing in which the sole FIGURE schematically illustrates in a functional manner a part of a communication network comprising a bus to which three electronic devices are connected in parallel of which one is provided with an exemplary embodiment of a device for checking frames in accordance with the invention.

The attached drawing can serve not only to complete the invention, but also to contribute to its definition, as the case requires.

### DETAILED DESCRIPTION

The invention addresses the particular problem of providing a device for checking frames D intended to be associated with a communicating electronic device O1 connected in parallel to a bus BU of a communication network RC.

It is considered in the following by way of non-limiting example that the communication network RC is a CAN LS (“Controller Area Network Low Speed”) network. However, the invention is not limited to this type of communication network. In fact, it concerns every type of communication network provided with a bus, and in particular CAN HS (“Controller Area Network High Speed”), VAN (“Vehicle Area Network”), LIN (“Local Interconnect Network”) and FlexRay networks.

Moreover, it is considered in the following by way of non-limiting example that the RC network is part of a vehicle, in particular, an automobile (as, for example, a car). However, the invention is not limited to this application. It relates, in fact, especially to land vehicles, boats and airplanes as well as to industrial installations comprising at least one RC communication network.

The sole FIGURE schematically illustrates a part of an RC (communication) network comprising a bus BU to which several communicating electronic devices Oj are connected in parallel and are intended to exchange information by means of multiplexed frames. In the non-limiting example illustrated three electronic devices O1 to O3 (j=1 to 3) are connected to the bus BU, and, more precisely, to its first electrical wire CH and second electrical wire CL , respectively called “CAN_L” and “CAN_H” and dedicated to the transport of frames of numeric data (or bits). However, the number of electric devices Oj of an RC network is not limited to three. In fact, this number must be at least equal to two so that there can be an exchange of frames.

The invention addresses the problem of providing a device D for checking frames intended to be coupled to an electronic device Oj. In the non-limiting example illustrated in the sole FIGURE only the first electronic device O1 is coupled to a device (for checking frames) D. However, several electronic devices, or even all electronic devices, can be coupled to a device (for checking frames) D in an RC network. In a general manner, it is advantageous that each electronic device that uses at least one local function of the type called non-secure (hereinafter, “non-secure local function”) used by a non-secure application AP that it comprises is coupled to a device D.

It is important to note that the phrase “electronic device Oj coupled to a device D” denotes the fact that the electronic device Oj is equipped internally with a device D (as illustrated in a non-limiting manner), as well as the fact that the electronic device Oj is connected to a device D. Consequently, a device D in accordance with the invention can be realized in the form of electronic circuits, software (or electronic data processing) modules or by a combination of electronic circuits and software modules.

When an electronic device is equipped internally with a device D, this device D can be implanted, for example (and as illustrated), in the application layer CA, which comprises each application AP running in this electronic device and connected to the unit grouping the physical and protocol layers CPP.

It is also important to note that the phrase “function of the non-secure type” (or “non-secure function”) denotes a function that is used by an AP application that is not capable of damaging the security of a person or of a piece of equipment when it is functioning. In the case of a vehicle it concerns, for example, a function of an application dedicated to the coded anti-starting or to the air conditioning or also to the pollution control (in the exhaust line). Moreover, the phrase “secure type function” denotes a function that is used by an application that is capable of damaging the security of a person or of a piece of equipment when it is functioning. In the case of a vehicle it can concern, for example, a function of an application dedicated to the speed control or to the braking (for example, the emergency braking or the ABS) or to the trajectory control (for example, the ESP) or to the control of sealed-beam headlights or to the power steering or to a “thermal event under the hood” (risk of engine destruction in case of non-functioning), or to the speed restriction or also to the uphill starting assistance.

As schematically and functionally illustrated in the sole FIGURE, a device D in accordance with the invention comprises at least a checking means MC for intervening each time that a frame is received from the RC network by the electronic device O1 with which it is associated.

More precisely, each time that the electronic device O1 receives from the RC network a frame comprising an error in at least one group of bits, the checking means MC will force the electronic device O1 to use as is at least each group of bits that is contained in the received frame and that is representative of a parameter of a non-secure local function used by an application AP of the electronic device O1.

In other words, when a frame is erroneous the checking means MC orders its electronic device O1 and, more precisely, each application AP of the electronic device O1, to use all the values of the non-secure parameters contained in the erroneous frame, even if some of them are erroneous.

Each erroneous bit group is generally detected by at least one of the protocol layers of the CPP unit (for example, the one charged with the calculation of the CRC or the one charged with the calculation of the checksum), then pointed out by the at least one protocol layer to the device D. It is noted that the function for managing faults (or errors) (“or fault handling CAN”) can also detect errors associated with functioning problems in the application layer of functions emitting parameters (in this case the consistency of the frame circulating on the multiplexed network is correct and therefore there is no detection of an anomaly by the protocol layers but the bit fields can be located out of the functional range, for example).

For example, and as illustrated in a non-limiting manner, the device D can comprise analyzing means MA that is charged with determining the type of each local function that uses an erroneous bit group that was signaled and pointed out by a protocol layer. It is recalled that the local function is either a secure local function or a non-secure local function. The analyzing means MA is then charged to point out to the checking means MC each erroneous bit group and the determined type (i.e., secure or non-secure) of the local function that must use the parameter value that this bit group represents.

Note that in a variant it is the checking means MC itself that can be designed to determine the type of each local function that uses an erroneous bit group that was detected and pointed out by a protocol layer.

In the exemplary embodiments described above it is the device D that is charged with checking the erroneous frames in order to take the decisions imposed regarding using or not using bit groups that they contain.

However, in a variant it is the electronic device O1 and more precisely one of its application layers (for example, a layer for managing faults (or errors) (“or fault handling CAN”) that can be in charge, by construction, of taking decisions in case of the detection of an erroneous frame. For example, the application layer can be designed in such a manner as to decide to replace a detected erroneous frame by a replacement (or overlay) frame comprising replacement bit groups with values selected (by default or by calculation).

In this case the checking means MC monitors the replacement frames generated by the previously cited application layer in such a manner as to force the electronic device O1 to use as is at least each bit group of a detected erroneous frame representative of a parameter of at least one non-secure function, including those that are erroneous, instead of each corresponding replacement bit group contained in a replacement frame supplied by this application layer. In other words, the checking means MC is placed at a hierarchal decision layer greater than that of the application layer. Note that the checking means MC can either authorize the use of the groups of a replacement frame that are representative of a parameter of a secure function and that have been replaced by replacement bit groups with the bit groups received for which they refused the replacement, or prevent the use of the bit groups of a replacement frame that are representative of a parameter of a secure function and that were replaced by replacement bit groups (in this case, the application concerned does not have values of the parameters of secure functions).

Note that in a variant, or also as a compliment, the checking means MC can also be designed such that when a received frame of the RC network contains an error in at least one bit group representative of a parameter of a local secure function, the checking means MC will force its electronic device O1 to use a replacement bit group with a selected value instead of the erroneous secure bit group.

In this case, each value selected for a bit group can be a value predefined by a default (for example, a value stored in a parameter/function value table).

Note also that the non-secure receiving function does not use the last valid value received but the real information circulating on the multiplexed network. If this real information develops when the frame is erroneous, the non-secure receiving function takes this development into account.

An example of the implementation of the invention will now be described in which the first electronic device O1 is a computer controlling the engine of a hybrid type vehicle or of an internal combustion engine with stop and start capabilities and comprising a coded anti-starting application AP (or ADC), the second electronic device O2 is a computer called BSI (built-in systems interface) and the third electronic device O3 is a computer called HPCU. This third electronic device O3 (HPCU) is the device that supervises the electrical network of a hybrid-type vehicle. It checks the electrical motors and also synthesizes the requests and information coming from the different computers connected to the network (for example, it is the electronic device O3 that determines the engine couple requested by the driver, taking into account the different treatments realized, in particular by the CMM, the computer of the gearbox and the cruise control).

It is recalled that the ADC application permits the preventing of the starting of the vehicle via the blocking of the injection when the communication (exchange of frames) between the first electronic device O1 (CMM) and the second electronic device O2 (BSI) is no longer ensured in an optimal manner (which is characteristic of a breach (for example, during a non-authorized change of CMM)). When the blockage of the injection is decided, it is said that the first electronic device O1 (CMM) is locked. Inversely, when the blockage of the injection has not been decided, it is said that the first electronic device O1 (CMM) is unlocked.

In order to determine if it should block itself, the first electronic device O1 (CMM) periodically sends an unlocking request on the RC network to the second electronic device O2 (BSI) and checks the response that the second electronic device O2 (BSI) is supposed to send to the first electronic device O1 (CMM) in return. If this response is in conformity with what it expects, then the first electronic device O1 (CMM) remains unlocked. In the contrary case the first electronic device O1 (CMM) is locked and thus prevents the starting of the vehicle.

This exchange of frames between the first electronic device O1 (CMM) and the second electronic device O2 (BSI) imposed by the ADC application should only take place in a unique situation of life: when the internal combustion engine is in the cut or stalled state. It should not be carried out when the engine is in the (temporary) stopped state decided by the stop and start application in order to not risk blocking the restarting of the vehicle when the driver so desires.

In order to determine the state in which the internal combustion engine is placed (and thus initiate or not the ADC communication with the second electronic device O2 (BSI)), the ADC application needs two pieces of information: the value during the course of the engine operation (rpm/min) and the state during the course of a “stop engine request” parameter that is controlled and emitted on the RC network by the third electronic device O3 (HPCU). The state of the “stop engine request” parameter is active when the third electronic device O3 (HPCU) requests the stopping of the internal combustion engine and inactive in the contrary case.

It will be understood that when the engine operation is zero and that a temporary stop of the internal combustion engine was requested and emitted on the RC network by the third electronic device O3 (HPCU) the first electronic device O1 (CMM) considers that the thermal engine is in the stopped state. The communication between the ADC application and the second electronic device O2 (BSI) is therefore not initiated and there is no risk of locking the first electronic device O1 (CMM). On the other hand, when the engine operation is zero and no temporary stop of the internal combustion engine was requested and emitted on the RC network by the third electronic device O3 (HPCU), the first electronic device O1 (CMM) considers that the internal combustion engine is in the cut/stalled state. The communication between the ADC application and the second electronic device O2 (BSI) is therefore initiated and it is possible to lock the first electronic device O1 (CMM) in the case of non-conformity or of the absence of a response from the second electronic device O3 (BSI).

If the frame emitted by the third electronic device O3 (HPCU) for requesting a temporary stop of the internal combustion engine is corrupted on the bus BU as a consequence of a physical or protocol disturbance, the frame becomes erroneous in the first electronic device O1 (CMM). For example, it can comprise a forbidden value of the engine operation (for example, reception of a value equal to 8100 rpm whereas the authorized value range is comprised between 0 and 8000 rpm. In this situation and in the absence of the implementation of the invention, the first electronic device O1 (CMM) will destroy the erroneous frame and replace it with a replacement frame containing default values for all the parameters that it contains. The ADC application will then use the content of the replacement frame. Now, the latter, containing a default value signaling that the parameter “stop engine request” is in the inactive state, initiates the communication with the second electronic device O2 (BSI), which ends in an undesired locking of the first electronic device O1 (CMM).

This situation cannot occur when the invention has been implemented, due to the fact that the device D forces the first electronic device O1 (CMM) to use the erroneous (or corrupted), and therefore real value, of the engine operation (non-secure parameter) that is contained in the erroneous frame received, and not a default replacement value, thus permitting the first electronic device O1 (CMM) not to be unnecessarily locked.

Note that the implementation of the invention in the case of the ADC application is only one example among numerous others.

It is also important to note that the invention can be also considered from the angle of a process for checking frames that can be especially implemented by means of a device D for checking frames of the type previously presented. Since the functionalities offered by the implementation of the process in accordance with the invention are identical to those offered by the device D previously presented, only the combination of main functionalities offered by the process is presented in the following.

This process comprises, in the case of the detection in a frame received from the RC network by an electronic device O1 of an error in at least one bit group, in forcing this electronic device O1 to use as is at least each bit group of the received frame that is representative of a parameter of a local non-secure function used by this electronic device O1.

The invention is not limited to the embodiments of the device for checking frames, of the electronic device and of the process for checking frames described above solely by way of example but it encompasses all variants that a person skilled in the art can envisage within the scope of the following claims.

1. A device for checking frames of received bit groups for an electronic device intended to be connected to a communication network and using at least one local function of the type called non-secure, characterized in that the device comprises checking means designed, in the case of the presence in a frame received from the network of an error in at least one bit group, to force this electronic device to use as is at least each bit group of this received frame that is representative of a parameter of a local function of the non-secure type used by the electronic device.

2. The device for checking frames according to claim 1, characterized in that it comprises analyzing means adapted to determine the type of each local function using a detected, erroneous bit group in such a manner as to point out the determined type of local function to the checking means.

3. The device for checking frames according to claim 1, characterized in that the checking means is adapted to determine the type of each local function using a detected, erroneous bit group.

4. The device for checking frames according to claim 1, characterized in that the checking means is adapted in case of the detection by the electronic device of a received frame containing at least one bit group representative of a parameter of a local, non-secure function, then of a decision to replace this detected, erroneous frame by a replacement frame comprising replacement bit groups with selected values, to force the electronic device to use as is at least each bit group of this detected, erroneous frame representative of a parameter of at least one non-secure function instead of the corresponding replacement bit group contained in the replacement frame.

5. The device for checking frames according to claim 1, characterized in that the checking means is adapted, in case of the presence in a frame received from the network of an error in at least one bit group representative of a parameter of a local function of the type called secure, to force the electronic device to use a replacement bit group with a selected value instead of the erroneous secure bit group.

6. The device for checking frames according to claim 5, characterized in that the selected value is a predefined default value.

7. The device for checking frames according to claim 1, characterized in that the electronic device is intended to be connected to a communication network (RC), and that the electronic device comprises the device for checking frames.

8. A method for checking frames of received bit groups for an electronic device intended to be connected to a communication network and using at least one local function of the type called non-secure, characterized in that the method comprises, in case of the detection in a frame received from the network of an error in at least one bit group, forcing the electronic device to use as is at least each bit group of the received frame that is representative of a parameter of the local function of the non-secure type used by the electronic device.

9. The method according to claim 8, characterized in that it furthermore comprises, in case of the detection in a frame received from the network of an error in at least one bit group representative of a parameter of a local function of the type called secure, forcing the electronic device to use a replacement frame comprising bit groups with selected values instead of the erroneous secure bit group.

10. (canceled)
